(19) United States
(12) Patent Application Publication
(10) Pub. No.: US 2005/0048459 A1
(43) Pub. Date: Mar. 3, 2005

(54) Educational toy with actuators and correlated audible and visual output

(76) Inventors: Domenic T. Gubitosi, East Aurora, NY (US); Christopher J. Hayes, West Falls, NY (US); John Keller, Buffalo, NY (US); Erica Nissen, Buffalo, NY (US); Robert J. Sonner, South Wales, NY (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/651,240

(22) Filed: Aug. 29, 2003

(51) Int. Cl. G09B 7/00

(52) U.S. Cl. 434/342

(57) ABSTRACT

The invention includes a body defining a viewing aperture. An opaque substrate bearing a first image and a second image is disposed within the body and is movable between a first position in which the first image is disposed within the viewing aperture and a second position in which the second image is disposed within the viewing aperture. An output generator is coupled to the body and is configured to generate a first output associated with the first image when the substrate is disposed in the first position and a second output associated with the second image when the substrate is disposed in the second position.

### BACKGROUND

1. Field of the Invention

The invention relates to an educational toy for children. More particularly, the invention relates to an educational toy having multiple outputs associated with an image displayed in a viewing location.

2. Discussion of the Related Art

Toys that facilitate learning experiences for children have been provided to stimulate the development of infants and young children. Some educational toys produce a variety of outputs, including audible and visual outputs. Educational toys that generate various audible and visual outputs, however, may require an ambient light source to enable adequate visual output, and can further require that the user look through a small aperture held in close proximity to the user's face. Such devices are not well suited for use by small children who are unable to properly manipulate the device into the proper position and/or orientation. Some viewing systems require a degree of ambient light such that an image located on a transparent disk may be easily viewed through an associated viewer.

Another problem associated with existing educational devices is that audible outputs are limited to a single output associated with every image. Thus, the learning experience provided for a user is limited. Such devices are not effective to hold the attention of children for any appreciable period of time.

Thus, there is a need for an educational toy for children that will enhance the learning experience available to a user. More specifically, there is a need for a toy that selectively displays multiple images and various audible outputs, each of the audible outputs being associated with a particular image.

### SUMMARY OF THE INVENTION

The invention includes a body defining a viewing aperture. An opaque substrate bearing a first image and a second image is disposed within the body and is moveable between a first position in which the first image is disposed within the viewing aperture and a second position in which the second image is disposed within the viewing aperture. An output generator is coupled to the body and is configured to generate a first output associated with the first image when the substrate is disposed in the first position and a second output associated with the second image when the substrate is disposed in the second position.

In another embodiment, the invention includes disposing a substrate bearing a first image in a first position, and producing a first sensory output associated with the first image, and disposing the second image in a second position, and producing a second sensory output associated with the second image.

These and other aspects of the invention will become apparent from the following drawings and description.

### BRIEF DESCRIPTION OF THE DRAWINGS

The invention is described with reference to the accompanying drawings. In the drawings, like reference numbers indicate similar elements.

FIG. 1 is a schematic drawing of a device according to an embodiment of the invention.

FIG. 2 is a functional block diagram illustrating the relationship between various components of an exemplary device according to one embodiment of the invention.

FIG. 3 is a perspective view of a device according to an embodiment of the invention.

FIG. 4 is a perspective view of an exemplary actuator configured for use with a device according to an embodiment of the invention.

FIG. 5 is a partial cut-away view of the device illustrated in FIG. 3 detailing elements of an exemplary image-advancing system according to an aspect of the invention.

FIG. 6 is a side elevation of the image-advancing system for use in the device illustrated in FIG. 3.

FIG. 7 is a schematic view of an output generator according to an embodiment of the invention.

FIG. 8 is an exploded view of components included in an exemplary drive system associated with the output generator according to an embodiment of the invention.

FIG. 9 is a top plan view of the output generator according to an embodiment of the invention.

FIG. 10 is a flow chart illustrating a method according to one embodiment of the invention.

FIG. 11 is a partial perspective view of a component of the device according to an embodiment of the invention.

FIG. 12 is a partial plan view of the substrate for use with the device according to an embodiment of the invention.

FIG. 13 is a perspective view of a device according to another embodiment of the invention.

FIG. 14 is a schematic showing one exemplary wiring configuration for components that may be used with the invention.

FIG. 15 is a schematic showing one exemplary wiring configuration for a control and drive system that may be used with the invention.

FIG. 16 is a cross sectional view of another embodiment of the invention.

FIG. 17 is an exploded view of an image advancing mechanism according to another embodiment of the invention.

FIG. 18 is an exploded view of some of the components of an image advancing mechanism according to another embodiment of the invention.

FIG. 19 is a circuit board having a number of contacts according to another aspect of the invention.

### DETAILED DESCRIPTION

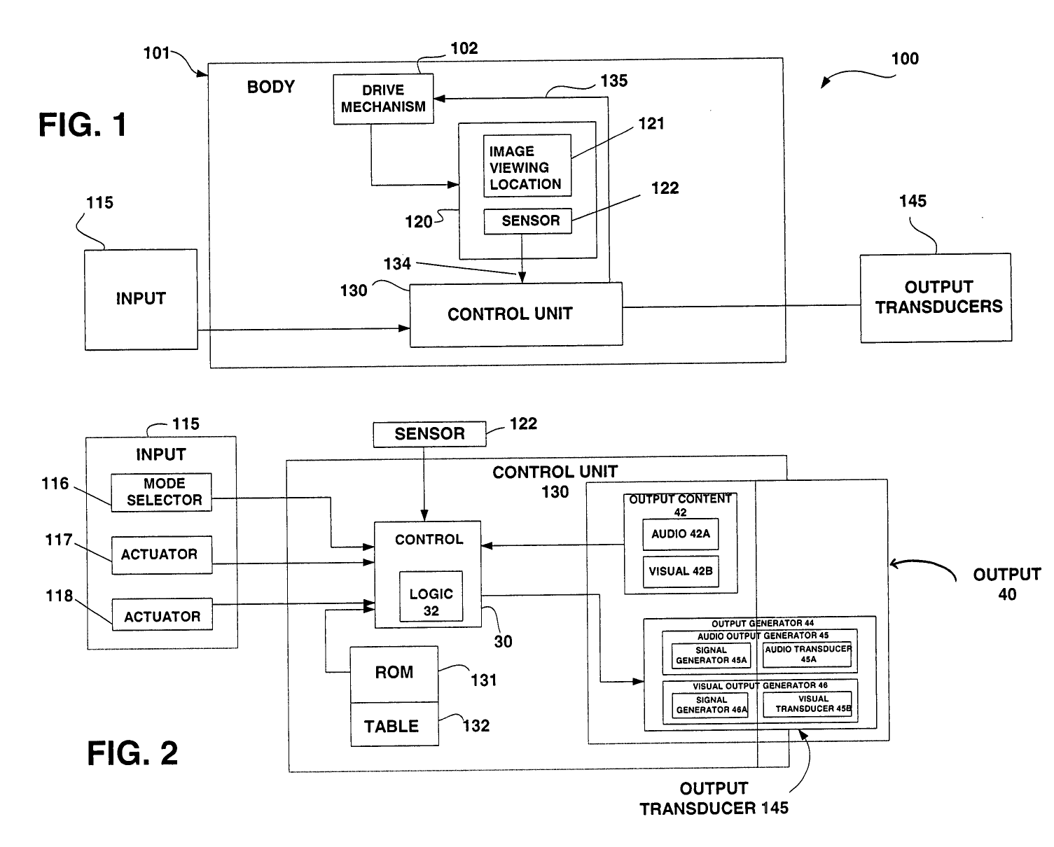

Several embodiments of a children's entertainment device 100 incorporating the principles of the invention are shown in FIGS. 1-19 A general description of the device is presented first, followed by a description of various embodiments that may be realized using the principles of the invention.

FIG. 1 is a schematic illustration of the relationship of various components of device 100. As illustrated in FIG. 1, the device 100 includes a body 101, having an image viewing location 121 disposed therein. An image advancing mechanism may also be disposed within the body 101, and is configured to selectively dispose one of multiple images in image viewing location 121. The images may include images that are pleasing to a child. A drive mechanism 102 is coupled to the image advancement mechanism 120 to drive the mechanism. An actuator may be coupled to drive mechansim 102. The actuator may be configured to be activated by a user to drive image advancing mechanism 120.

A sensor, such as an optical sensor, may be configured to determine which images of the multiple images is being displayed in the image viewing location 121 by detecting a code located on a substrate upon which the images are located (described below). Each image may have a code associated with it.

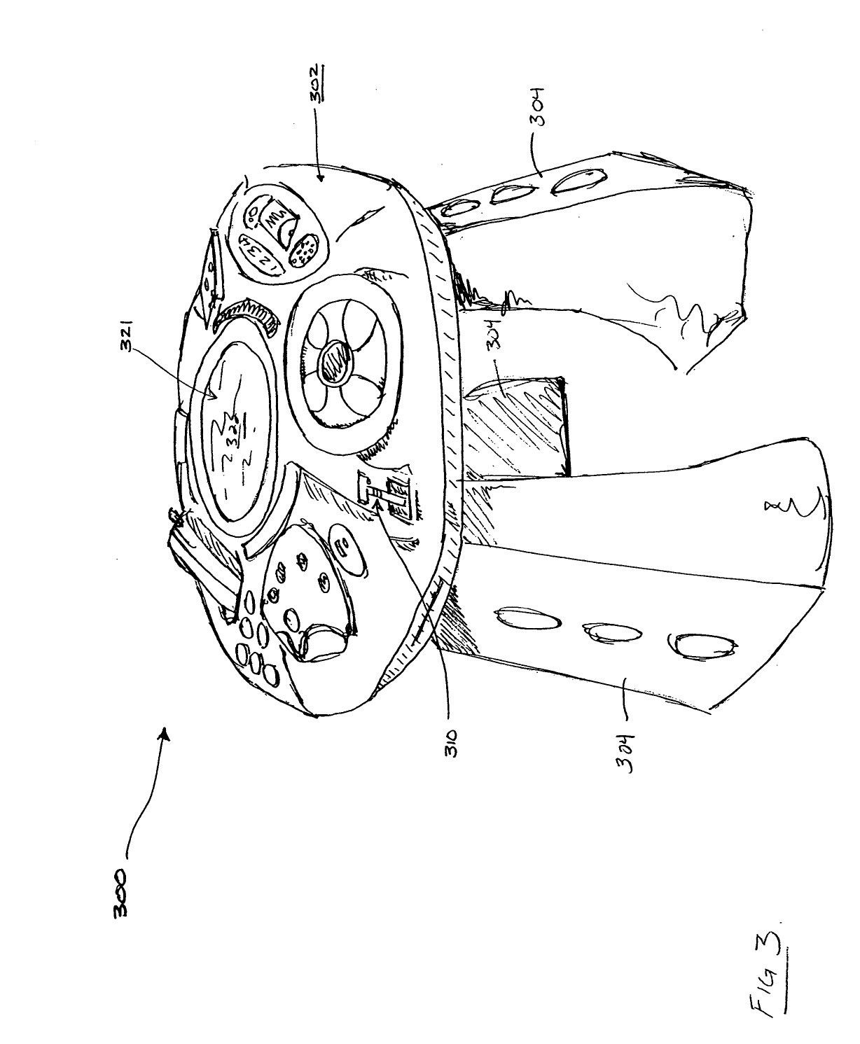

A control unit 130 is disposed in body 101 and is coupled to sensor 122 over bus 134 and to drive mechanism 102 over bus 135. As illustrated in further detail in FIG. 2, the control unit 130 may include a read-only memory (“ROM”) 131 and a look-up table 132, or other data storage structure that may store information to be accessed by a microprocessor or other control system. Control unit 130 may be configured to receive information from sensor 122 pertaining to the image being disposed within the image viewing location 121. Sensor 122 may detect a code associated with an image on the substrate (not illustrated in FIGS. 1 and 2), and output a sensor signal to the control unit 130 over bus 134. The control unit 130 may then access the ROM 131 to determine which output(s) is associated with the detected code. The code may include image identification data and a “STOP” command, which indicates to the controller 130 when to issue a “drive stop” command. This “drive stop” command may be issued when the image is disposed in the desired position relative to the image viewing location.

Referring again to FIG. 1, device 100 may also include output transducers 145. When an image is positioned in the image viewing location 121, an output generator may produce an output that is perceptible by a user. As depicted in FIG. 2, the output transducers may include one or more output transducers and may include an audio output transducer 145A and visual output transducer 145B. While the depicted embodiment illustrates one audio output transducer 145A and one visual output transducer 145B, any number of audio and visual output transducers may be included. For example, three audio output transducers may be used, while no visual output transducers need be present. The output transducers 145 are configured to generate sensory output that is perceptible by a user when a particular image is disposed in the viewing location 121. When the image is disposed within the viewing location 121, a sensory output associated with that image may be produced. For example, if an image of a fire truck is disposed in the image viewing location 121, the output may indicate that the color of the fire truck is “red.” Alternatively, fire truck sounds may be output. In an alternative embodiment, the output may indicate that the word “fire truck” beings with the letter “F.”

As depicted in FIG. 2, multiple actuators 117, 119 may be provided. Each of the actuators may be configured to produce a different output associated with the image disposed in the viewing location 121. As one of skill in the art will realize, the invention as described herein is equally applicable using any number of actuators and output transducers.

As described above, FIG. 2 is a functional diagram of the control unit 130. Control unit 130 includes an input block 115, a control block 30, and an output block 40.

The input block includes a mode selector 22, a first actuator 117, and a second actuator 118, by which a user may provide an input to the control 30. Mode selector 116 may have a number of different functions. Mode selector 116 may allow the user to select from various audio and visual output modes. Illustrative output modes include variations of combined video and audio output. For example, audio content 42A may include a set of spoken words (or other prerecorded speech phrases), or a set of musical notes or compositions, and video content 42B may include an image associated with the words, or various modes of light operation (in addition to the image disposed in the viewing location).

Actuators 24 and 26 may be disposed on the outer surface of body 101. Actuators 24 and 26 may allow the user to apply simple commands to control unit 130, such as “start,” “stop,” “repeat,” “advance,” and “rewind” via simple mechanisms such as mechanical contact switches.

Control block 30 controls the output block 40 based on input received from input block 115. Control block 30 may be configured to select the output content to be output by the output transducers 145, and activate the output generator 44 to operate on the selected output content. The operation of control block 30 may be governed by control logic 32. Control logic 32 is configured to select content to be output repetitively or non-repetitively, and/or randomly or in fixed sequences. The video and audible output can be coordinated to enhance the pleasing effect of the sensory output.

Output block 40 includes output content 42, which includes audio content 42A, and video content 42B. Audio content 42A can include, for example, in either digital or analog form, musical tones (which can be combined to form musical compositions), speech (recorded or synthesized), or sounds (including recorded natural sounds, or electronically synthesized sounds). Video content can include still or video images, or simply control signals for activation of motors to advance images, lamps or other light-emitting devices. The images may be in analog or digital form.

The output content 42 may be communicated to a user for hearing, or viewing, by output generator 44, which can include an audio output generator 45, and a video output generator 46. Audio output generator 45 can include an audio signal generator 45A, which converts audio output content 42A into signals suitable for driving an audio transducer 45B, such as a speaker, for converting the signals into audible sound waves. Video output generator 46 can include a video signal generator 46A, which converts video output content 42B into signals suitable for driving a video transducer 46B, such as a viewable image, a display screen or lights, for converting the signals into visible images. Video output generator 46 can also include moving physical objects, miniature figures, etc. to produce visual stimulus to the user.

The selection of the output content, and the performance attributes of the output generators, are preferably driven by the goal of generating output that is entertaining and educational to a user.

To use the device 100, the user may select an output mode with the mode selector 116 and issue a “start” command via an actuator 117 or 118. The control block 30 may receive the mode selection and the “start” command, select the corresponding output content, and activate the output generator 44 to generate the selected output content. Moreover, the actuator 24 or 26 may be used to advance and/or rewind the image-bearing substrate to selectively dispose different images in the viewing window as described above.

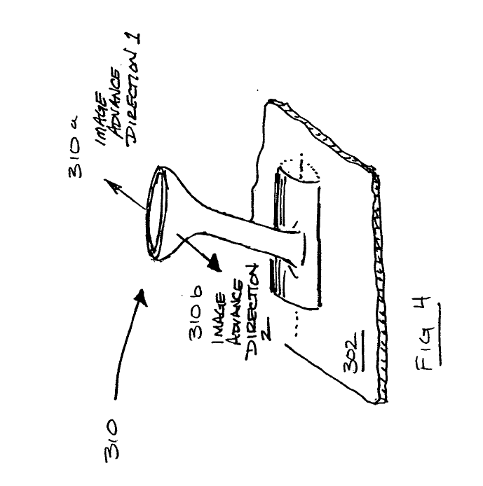

FIGS. 3-9 illustrate an exemplary toy according to an embodiment of the invention. Toy table 300 is illustrated in FIG. 3, and includes a body or housing 302, which may resemble a table top. In the illustrated embodiment, the housing 302 is supported by multiple legs 304. The legs 304 may be adjustable in height and may be removably or fixedly coupled to the housing 302.

Housing 302 may define an aperture or image viewing location 321, through which an image disposed on an underlying image-bearing substrate (described below) may be viewed. In the illustrated embodiment, the aperture 321 is covered by a transparent covering. Selected portions of the substrate may be selectively positioned within the image viewing location by activating a drive mechanism (described below) using actuator 310. Actuator 310 may be a lever, a button, a switch, a dial, or any other type of actuator. The actuator 310 may be configured to activate the drive mechanism to move the substrate in any direction past the viewing location.

An exemplary embodiment of the actuator is illustrated in FIG. 4. The actuator 310 is depicted as a lever, but may be of any configuration, as described above. The lever may be configured to be moved by a user about a pivot axis in one of two directions. For example, the substrate may be advanced from left-to-right when the actuator 310 is pressed towards “image advance direction 1,” 310a, and may advance the substrate from right-to-left when the actuator 310 is pressed towards “image advance direction 2,” 310b.

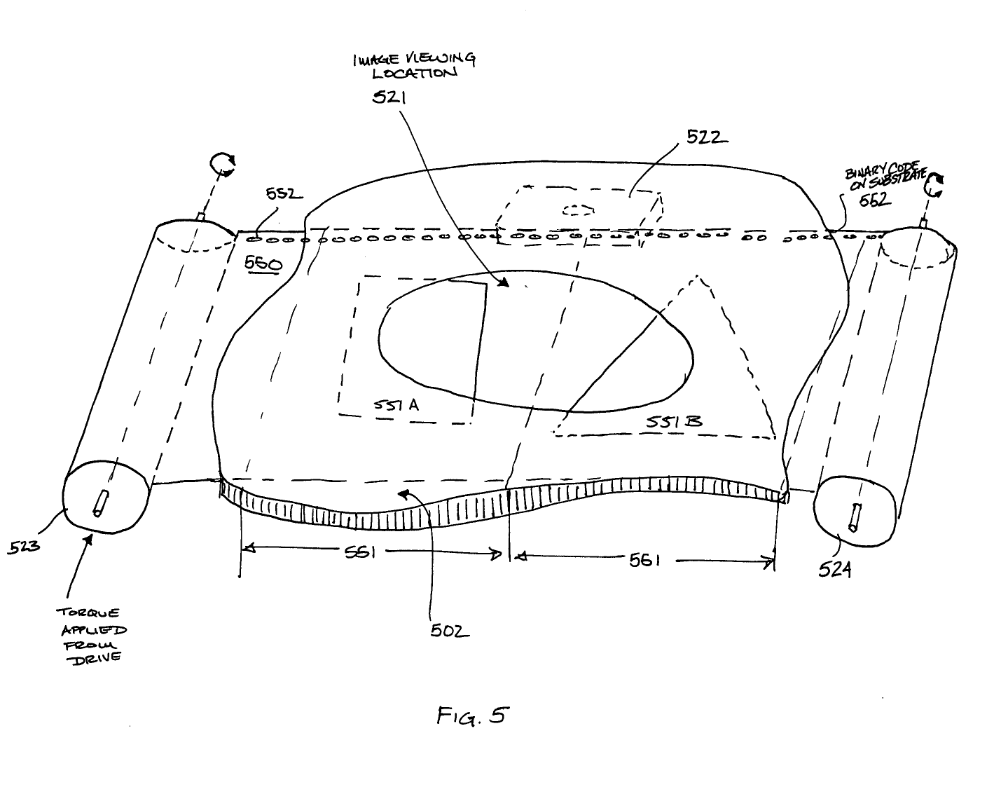

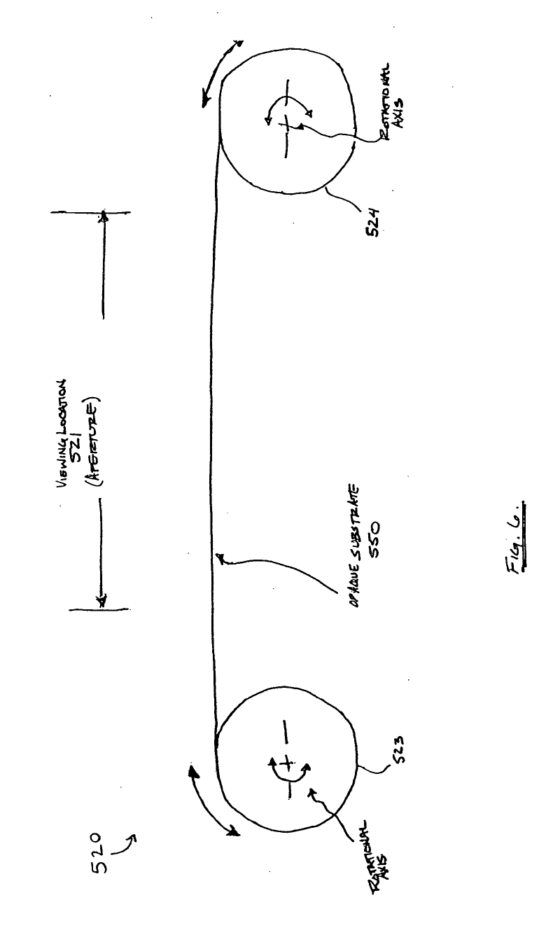

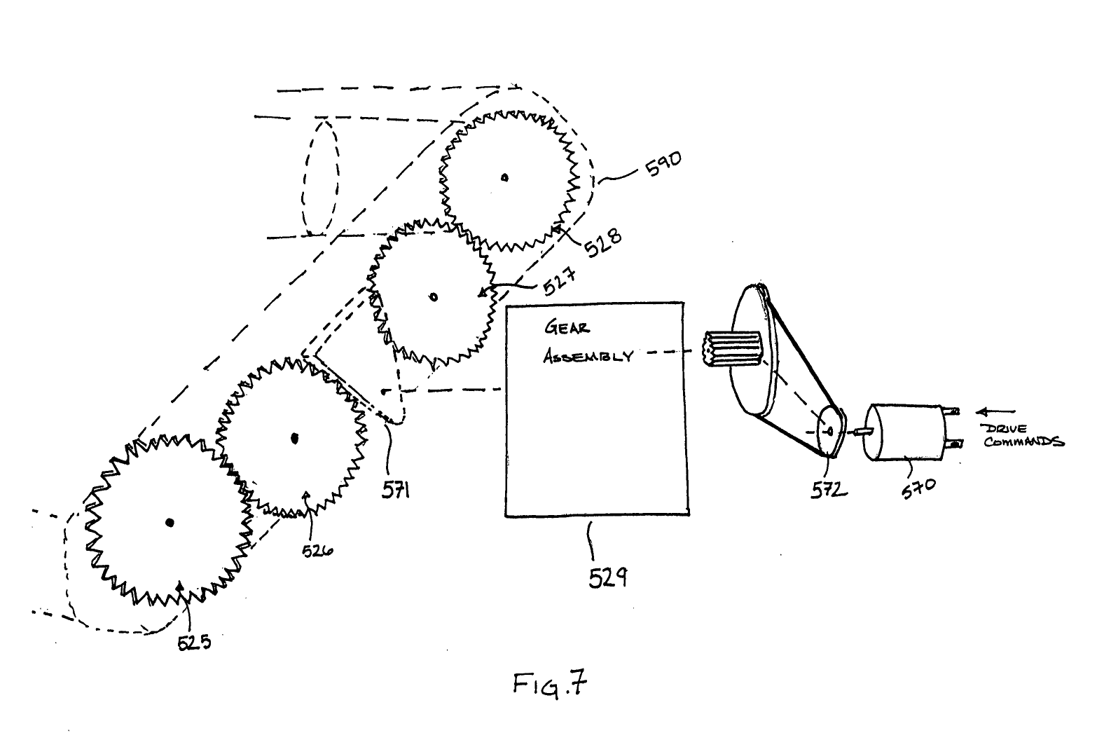

As shown in FIG. 5, toy 300 includes an image-bearing substrate 550 having various images disposed thereon that can be selectively positioned under aperture 321. Substrate 550 may be formed from a flexible sheet of opaque material. The images can be disposed on substrate 550 by being directly printed thereon by silk screening or any other manner such that they are easily visible, or can be formed separately and attached to the substrate, such as by adhesives. The opaque substrate 550 includes image-bearing portions 551 that include the images that are to be selectively disposed in the viewing location 521. For example, in the embodiment illustrated in FIG. 5, two image-bearing portions 551 are positioned adjacent the viewing location 521. Movement of substrate 550 in either direction could bring either one of the image-bearing portions 551 into registration with, and therefore viewable through, the viewing location. In the illustrated embodiment, the viewing location 521 is an aperture in the body 502. The images disposed on the substrate 550 may be separate, unassociated images or may be related images or a continuous image that includes various sections (e.g., portions of a storybook, discrete components of a larger picture). Regardless of the nature of the images on the substrate, preferably only one image-bearing portion 551 of the substrate 550 may be viewable through the viewing location 521 at a given time. Substrate 550 can be advanced to dispose different images beneath aperture 321 by an image advancing system or drive mechanism 520, illustrated in FIGS. 5 and 6

In the illustrated embodiment, image advancing system 520 includes a first spool 523 and a second spool 524 that support image-bearing substrate 550. Either spool 523 or 524 may function as the supply spool or the take-up spool, depending on the direction that substrate 550 is traveling. For example, when the substrate 550 is traveling from left to right in FIG. 5, spool 523 is the supply spool and spool 524 is the take-up spool.

The spools 523 and 524 have a portion of opaque substrate 550 wound about the spool structure. Substrate 550 may be a flexible sheet of plastic, heavy paper, or other durable and flexible material suitable to be wound about spools 523 and 524.

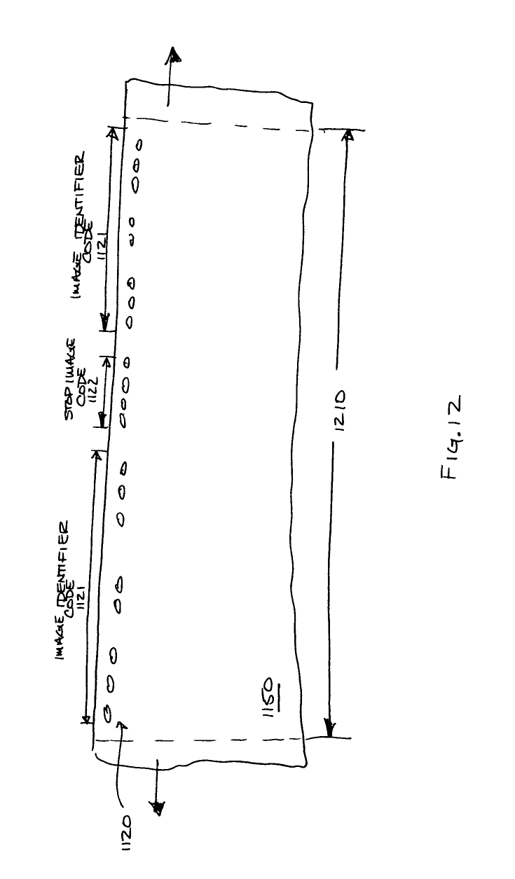

The opaque substrate 550 bears multiple images. For example, opaque substrate 550 may have multiple image-bearing portions 551, each of which bear an image. As illustrated in FIG. 5, one image-bearing portion 551 bears a first image 551A, while another bears a second image 551B. The substrate 550 may include a code portion 552 disposed on a portion of the substrate. In the exemplary embodiment illustrated in FIG. 5, the code portion 552 is disposed along an edge of the substrate 550. The code may include identification information associated with a particular image 551A or 551B to permit the control unit (described above) to generate the output associated with the identified image. In addition to the identification information, the code may include a “stop” code, which, when output to the control unit 130, will cause the control unit to issue a “drive stop” command, as discussed above. Further description of the codes that may be used with the invention are described in further detail with respect to FIG. 12.

The code disposed on code portion 552 of substrate 550 may be detected by sensor 522. In one embodiment of the invention, the sensor may be an optical sensor. The optical sensor may include an emitter and a detector. Sensor 522 may detect which image is disposed in the viewing aperture by sensing a binary code on code portion 552, and relaying the image information to the control unit 130.

While in the embodiment depicted in FIG. 5 has a sensor disposed in the center of the viewing aperture, other embodiments with the sensor being disposed at a leading or trailing edge of the viewing aperture may be realized. The sensor 522 may be located anywhere that it may detect the image that is located in the image viewing location 521.

The operation of the drive mechanism, the spooling configuration, and the sensor will now be described with reference to FIG. 5. When a command to advance the image in a first direction is received, a drive mechanism, which may be a DC motor (not pictured) may apply a torque to a spool 523 in a first direction. As the spool rotates, the substrate disposed around spool 524 may begin to unwind. In this exemplary arrangement, spool 523 is a take-up spool and spool 524 is a supply spool. As torque is applied to spool 523, image-bearing portions 551 (and correspondingly images 551A and 551B) advance from right to left as they pass below the aperture in the housing 502.

Sensor 522 may be configured to detect a binary code on code portion 552 on the edge of the substrate 550 as the substrate is moved from right to left. Sensor 522 may determine which image is disposed within image viewing location 521 by detecting the binary code. When the sensor detects a “drive stop” code within the binary code, the control unit may issue a “drive stop command” which will cease the application of torque to spool 523. Additionally, when the control unit receives the detected “drive stop” code, the control unit may issue a signal to the output generator to have the output generator generate a sensory output that is perceptible to a user.

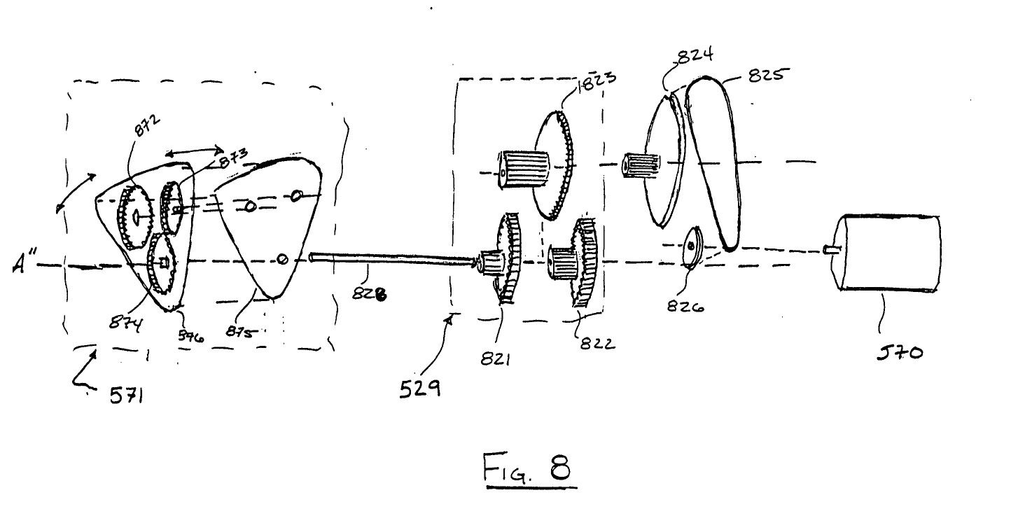

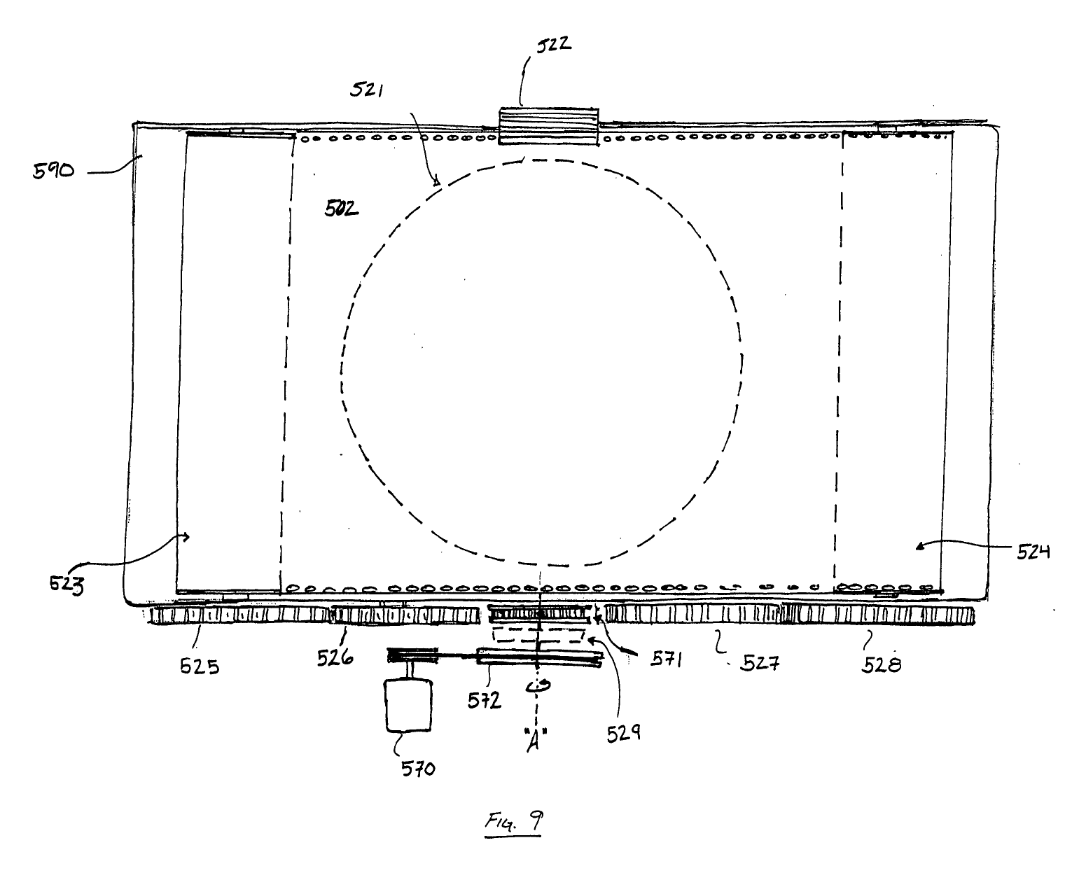

FIG. 7 illustrates an exploded view of the image advancing system according to an embodiment of the invention. FIGS. 8 and 9 illustrate an exploded view of the gear assemblies and the assembled drive mechanism, respectively. As illustrated in FIG. 7, the drive mechanism may be a DC electric motor 570, although other suitable drive mechanisms will be apparent to those of skill in the art. Motor 570 may be coupled via a pulley system 572 (including two pulleys connected by an elastic drive band) to a reduction gear assembly 529. In turn, reduction gear assembly 529 is coupled to a reversing gear assembly 571, which is a triangular arrangement of gears mounted to a frame (indicated by the dashed line) that is pivotally coupled to a spool support structure 590.

FIG. 8 is an exploded view of reduction gear assembly 529 and reversing gear assembly 571. Reversing gear assembly 529 may include three gears 823, 822, and 821 (gears 822 and 821 being commonly mounted on axle 828) that are configured to reduce the drive rotational speed from the pulley assembly 572 to the reversing gear assembly 571.

Reversing gear assembly 571 may also include three gears, 872, 873, and 874, which are mounted to, and disposed between, two plates 875, 876. As discussed above with respect to FIG. 7, plates 875, 876 (and thus reversing gear assembly 871) may be pivotably coupled to the spool housing 590 on axle 828 (having axis “A”). In this way, either gear 872 may engage gear 526 (if motor 570 drives pulley assembly 572 and reduction gear assembly 529 in a first rotational direction), or gear 873 may engage gear 527 (if motor 570 drives pulley assembly 572 and reduction gear assembly 529 in a second, opposite rotational direction). Thus, reversing gear assembly 571 enable substrate 550 to be driven in either of two opposite directions according to the rotational direction of motor 570.

FIG. 9 illustrates a top view of the drive mechanism and the image viewing location according to an embodiment of the invention. The operation of the device depicted in FIGS. 7-9 will now be described.

The motor 570 may receive an “image advance” signal from the control unit (described above). The motor may then apply a rotational energy through pulley and belt system 572. Pulley and belt system may then transfer the rotational energy to the reduction gear assembly 529, which in turn drives reversing gear assembly 571. Reversing gear assembly 571 then pivots into engagement with one of the gears 526 or 527, and in turn drive one of gears 525 or 526 to rotate one of spools 523, 524. The spools will then supply and take-up the supplied substrate such that images disposed on the substrate are advanced through the viewing location 521. Depending on the rotational direction of the torque applied by motor, 570, the images disposed on the substrate may advance from right to left in FIG. 9 or from left to right in FIG. 9.

As described above, and discussed in further detail below, sensor 522 may detect a code disposed on the substrate. Sensor 522 may output a signal to a control unit (described above), which may issue a “motor stop” command when a “STOP” code is detected by the sensor.

The artisan will recognize that there are many alternative gearing arrangements by which power can be conveyed to an appropriate one of the spools based on the direction of rotation of motor 570. Alternatively, two motors (or other drive mechanism), one for each spool, may be used to directly drive the image advancing system in each direction. For example, one motor may drive the image advancing mechanism in a first direction upon receiving a first drive command, and a second motor may drive the image advancing mechanism in the other direction upon receiving a second drive command.

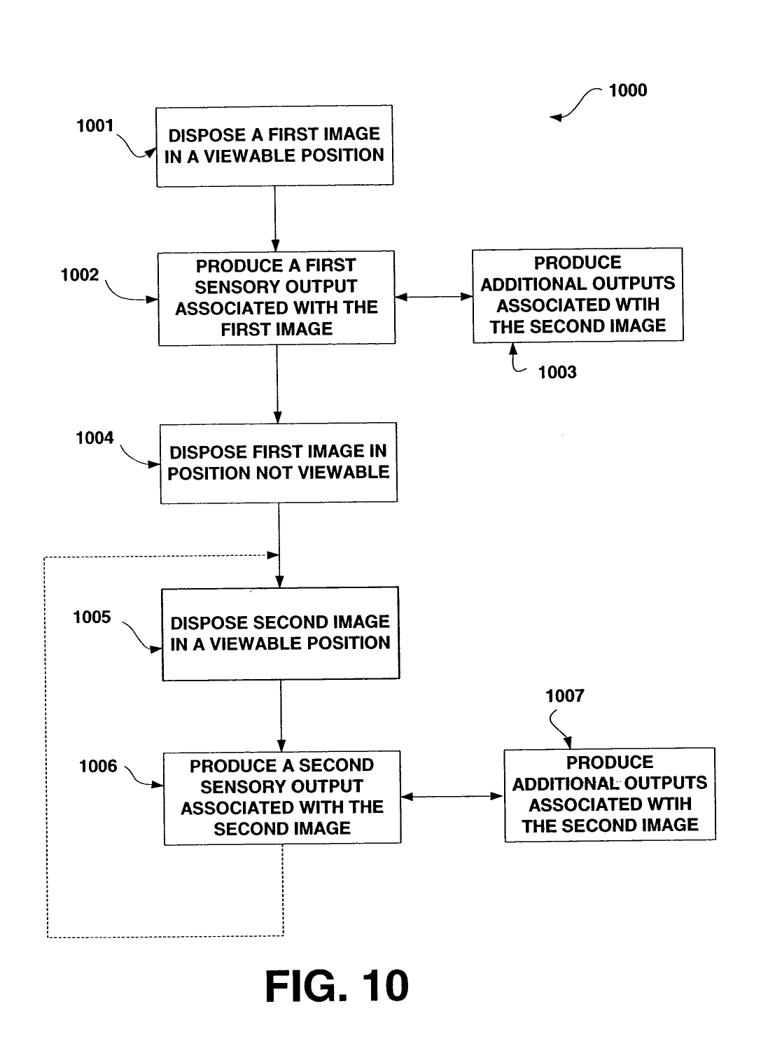

A method 1000 according to an embodiment of the invention is illustrated in FIG. 10. One method of practicing the invention begins in step 1001 with disposing a first image in a location that is viewable by a user. The image may be disposed in a viewing location or aperture, as described above. When the image is disposed in the aperture or viewing location, a first sensory output associated with the first image may be output at step 1002. This output may include audible output, visual output, and/or tactile outputs. The sensory output is preferably associated with the image in some way. For example, when an image of a green frog is disposed in the viewable position, the sensory output may include the speech output “frog,” which is produced by the audio output transducer described above. When the first image is disposed in a location viewable by the user, additional actuators may be used to generate additional outputs associated with the first image. For example, additional outputs may describe the frog as “green,” or may announce that the word frog begins with the letter “F.” Additionally, the output could be a “ribbit” sound or other sounds commonly associated with frogs. These additional outputs may occur over a period of time or may be based on the individual actuation of actuators.

Another aspect of the invention includes a number actuators associated with the image disposed in the viewing location. For example, one actuator may always initiate the output of the spoken pronunciation of a color associated with the displayed image. A second actuator may initiate the output of a sound effect associated with the displayed image. For example, if the image being displayed in the viewing location is a fire truck a siren may be produced. Another actuator may initiate the output of the spelling of what is shown in the displayed image. A further actuator may initiate the output of the spoken pronunciation of the number of articles illustrated in the displayed image. In addition, other sounds, lights or other sensory output may be produced.

Next, in step 1004, a user may cause the first image to be disposed in a position in which the image is not viewable by a user. A second image may then be advanced from a position not viewable by a user to a viewable position in step 1005. When the second image is in a position viewable by a user, a second sensory output may be produced, step 1007. In addition to the second sensory output, additional outputs may be produced by the user by actuating additional actuators as described above.

The process of disposing images in a location viewable by a user and then disposing the image in a location that is not viewable by a user may be repeated any number of times, as indicated by the dashed arrow in FIG. 10. As will be realized by the ordinarily skilled artisan based on this disclosure, any number of actuators may be provided to produce any number of sensory outputs associated with an image. For example, a single actuator may produce all of the sensory outputs associated with the viewable image. Alternatively, there may be multiple actuators, each associated with a particular output.

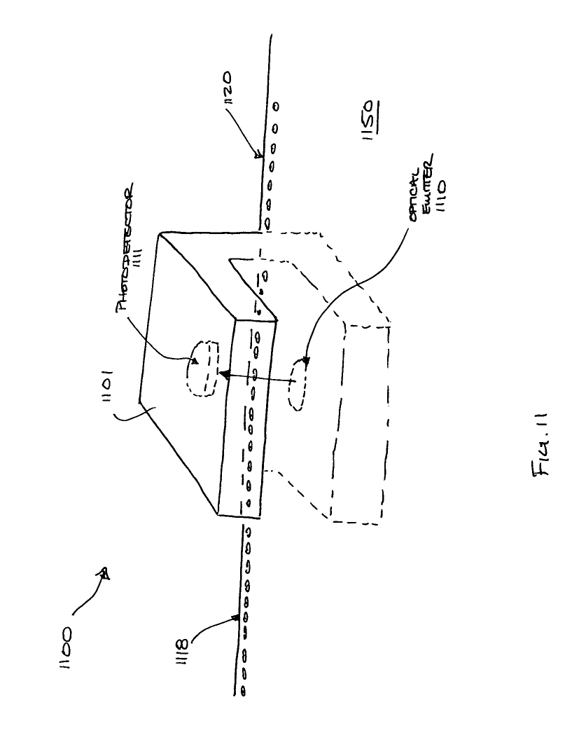

An embodiment of a sensor structure is illustrated generally in FIG. 11. Sensor 1100 may include a sensor body or housing 1101, that houses an optical emitter 1110 and a photo-detector 1111. The optical emitter 1110 and the photo-detector 1111 may be disposed within opposite arms of the substantially “C” shaped sensor housing. The sensor housing may be configured such that the substrate 1150 with code-bearing portion 1118 bearing a binary code 1122, may pass between the arms of the substantially “C” shaped sensor body 1101.

One embodiment of a code-bearing portion of an image-bearing substrate as described above is illustrated in FIG. 12. Code-bearing portion 1118 is disposed at the edge of substrate 1150, and is positioned adjacent image-bearing portion 1210 of substrate 1150. In the illustrated embodiment, code-bearing portion 1118 bears a binary code 1120, which is formed as a series of holes or apertures in image-bearing portion 1118. Sensor 1100 is disposed to read code 1120 as code-bearing portion 1118 passes by sensor 1100. Sensor 1100 may be positioned in the center of the viewing location, but may be disposed so as to be hidden by the housing defining the viewing location (described above).

Code 1120 includes image-identifying code 1121 and a “stop” code 1122. The code may be uniquely associated with a particular image such that the sensor may provide information to the controller about which image is disposed in the viewing location. As illustrated in FIG. 12, the code disposed on the substrate may be symmetrical, such that the image will be centered in the viewing location when it moves from a location hidden from a user to a location viewable by a user.

While a particular image sensor and code have been described as a series of holes in the substrate numerous other sensors and detectors along with other codes may be incorporated into a device using the invention without departing from the scope of the invention. For example, one side of the substrate may include bar-codes, and the sensor may be a bar code reader. Additionally other system may include RFID (radio-frequency identifier) tags that utilize small circuits energized by a radio signal to identify a particular image to a detector. Yet another alternative may include using reflective spots on the substrate such that the photo-detector and the emitter may be on the same side of the sensor body.

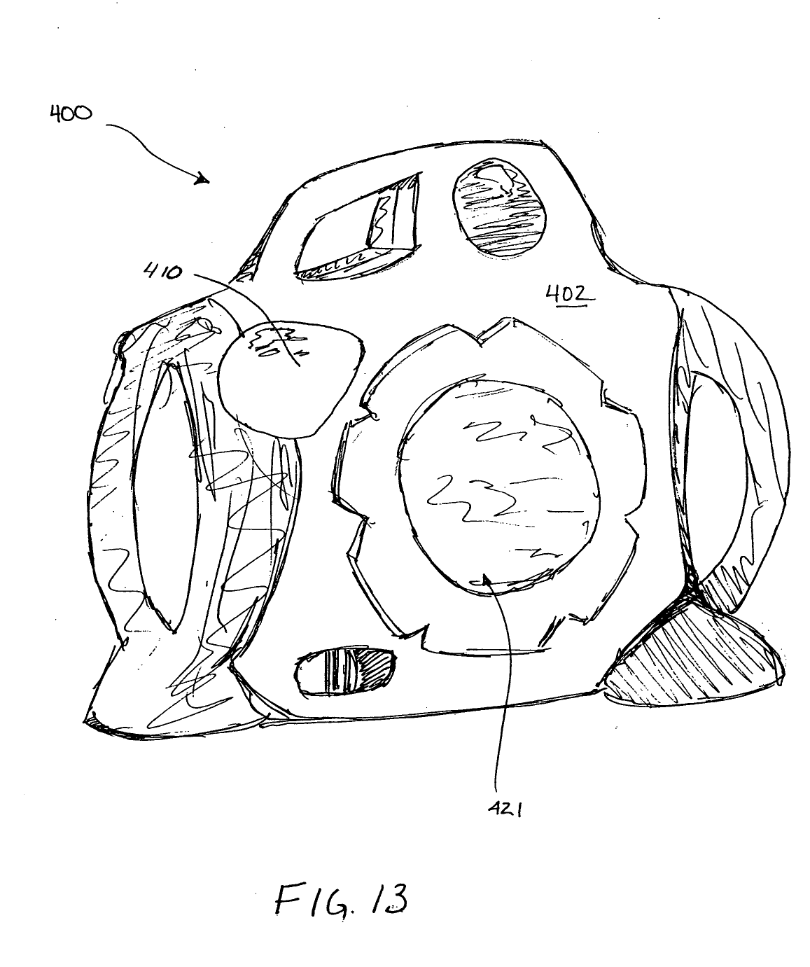

Another device employing the principles of the invention is illustrated generally in FIG. 13. In the illustrated embodiment, a toy camera includes a body or housing resembling a camera 402. A viewing location or aperture 421 may be defined within the body. Also disposed on the body is an actuator 410. The actuator may be configured to advance an image-bearing substrate disposed in the viewing location or aperture 421.

Camera 400 may function in substantially the same manner as the table embodiment described above. Alternatively, camera 400 may use an alternative image advancing mechanism, as will be described below.

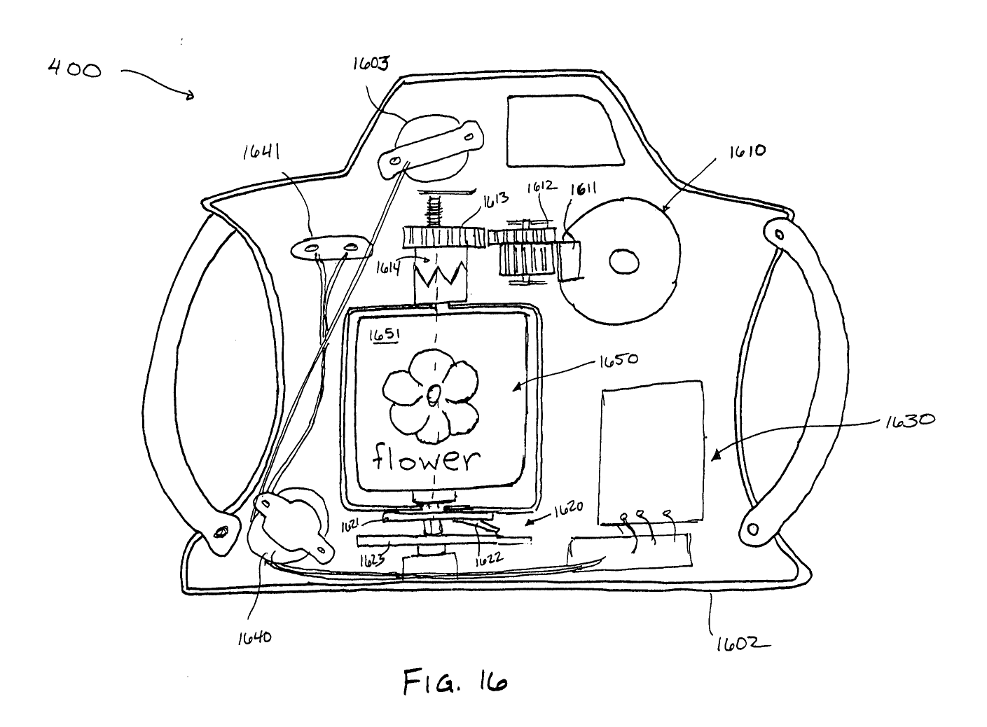

An alternative embodiment of a toy according to the invention is illustrated in FIG. 16. The toy includes an actuator 1610. Rack 1611 is mounted to actuator 1615, and is configured to engage first rotational gear 1612. Rotational gear 1612 engages second rotational gear 1613. Second rotational gear 1613 is coupled to an axle 1614 (illustrated as a dashed line where it passes through components). The axle is coupled to opaque image-bearing substrate 1650. In the illustrated embodiment image-bearing substrate 1650 is a rectangular prism. The axle is coupled to a image position detection system 1620. The image position detection system 1620 includes a disk 1621 coupled to axle 1614. A set of metal contacts 1622 are mounted to disk 1621. Contacts 1621 are configured to engage a circuit board 1623 (described below).

Camera 400 also includes an output system. The output system includes a speaker 1640 and an LED or other visual output source 1641.

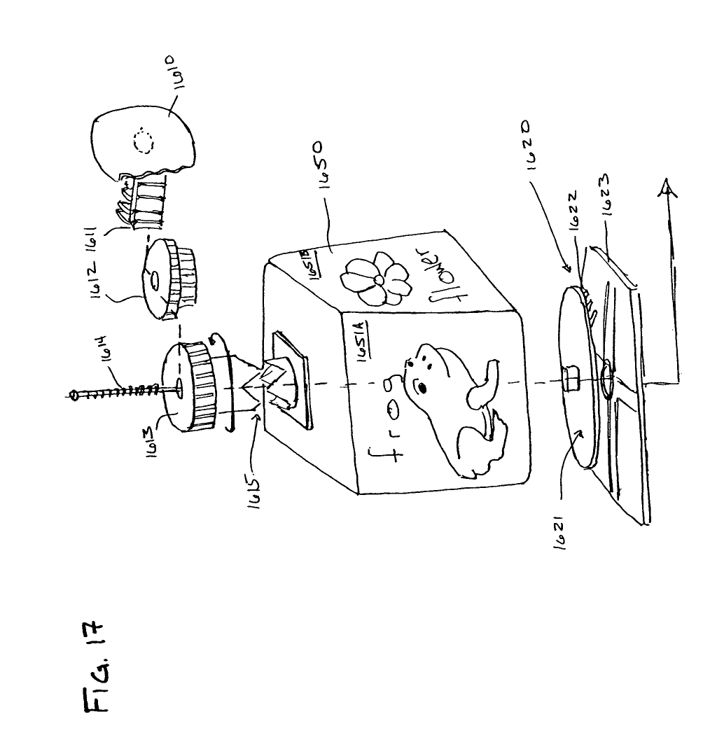

The functionality of camera 400 will now be described with reference to FIGS. 16-19. An actuator 1610 is configured to be depressed or otherwise actuated by a user. As shown in FIG. 17, actuator 1610 may be coupled to a rack, which is configured to engage a first gear 1612. The first gear is configured to engage second gear 1613. Second gear causes the opaque image-bearing substrate to rotate via axle 1614. As the image-bearing substrate is rotated, a different image may be disposed in the viewing location (as described above). Image centering mechanism 1615 includes a set of interlocking teeth that are configured to ensure that the image is located in the center of the image viewing location by preventing over and under rotation of the image-bearing substrate.

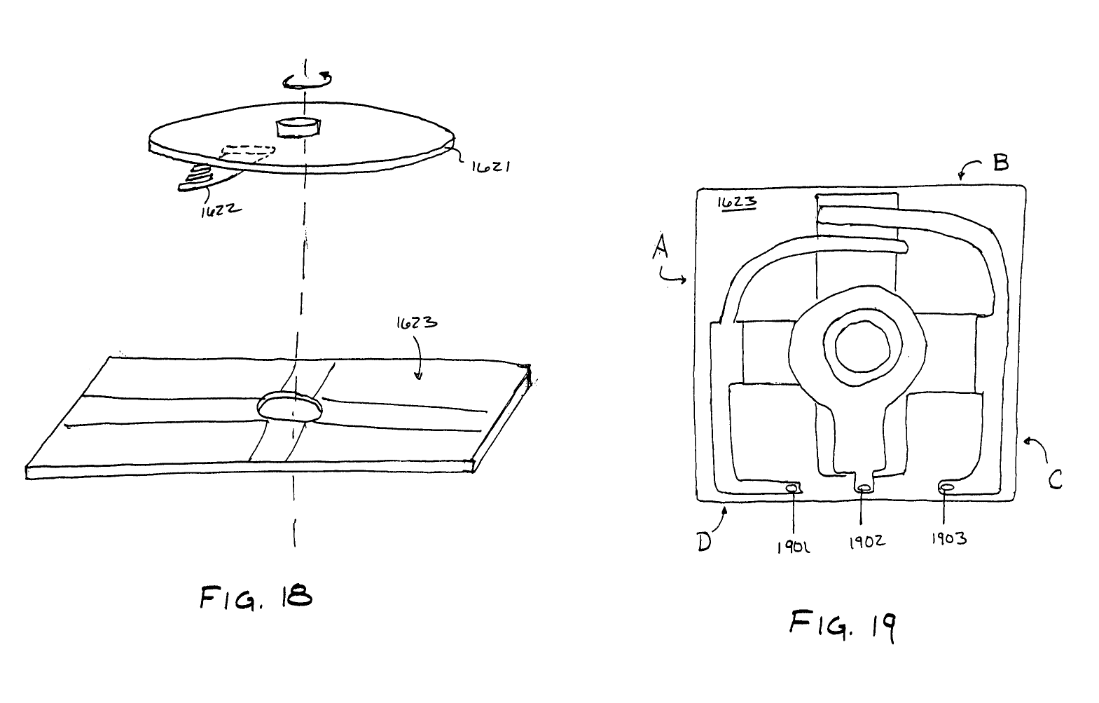

As the image-bearing substrate rotates, disk 1621 rotates as well. As illustrated in FIG. 18, disk 1621 includes electrical contacts 1622. As the disk 1621 rotates, the electrical contacts 1622 move across circuit board 1623, which has a number of electrical contacts. One possible configuration of the electrical contacts according to an embodiment of the invention is illustrated in FIG. 19. In the illustrated embodiment, circuit board 1623 is a rectangular circuit board, having sides “A,” “B,” “C,” and “D.” Depending on which of the images is disposed in the viewing location, metal contacts 1622 are positioned near one of sides A-D. Each of the positions associated with sides A-D includes a pattern of electrical contacts unique to that side. For example, in the exemplary embodiment illustrated in FIG. 19, when metal contacts 1622 are positioned adjacent to side “A,” metal contacts 1622 engage leads 1901 and 1902. When metal contacts 1622 are positioned adjacent to side “B”, metal contacts 1622 may engage leads 1901, 1902, and 1903. Likewise, when metal contacts 1622 are adjacent to side “C,” metal contacts 1622 may engage leads 1902 and 1903. When metal contacts 1622 are adjacent to side “D,” all of the metal contacts 1622 may engage lead 1902. Hence, each image has a unique pattern of circuit contacts associated with the particular image, thereby providing a unique output or set of outputs associated with the displayed image.

When a circuit is completed by the metal contacts 1622 engaging a particular set or subset of leads, 1901-1903, the controller 1630 may determine which image is disposed within the viewing location and may cause the output transducers 1640, 1641 to output the appropriate sensory output associated with the viewable image. Some exemplary sensory outputs are described above.

While a rectangular circuit board is illustrated in FIGS. 17-19, one of ordinary skill in the art will realize that a circuit board having any number of sides may be used to practice the invention. Additionally, while only three electrical contacts are illustrated, any number of electrical contacts may be used, depending on the number of images to be disposed on the opaque image bearing substrate 1650.

Although the image advancing mechanism is described as having rack 1611, first gear 1612, and second gear 1613, there are numerous alternative embodiments for imparting mechanical energy from an input actuator to a rotating image-bearing substrate.

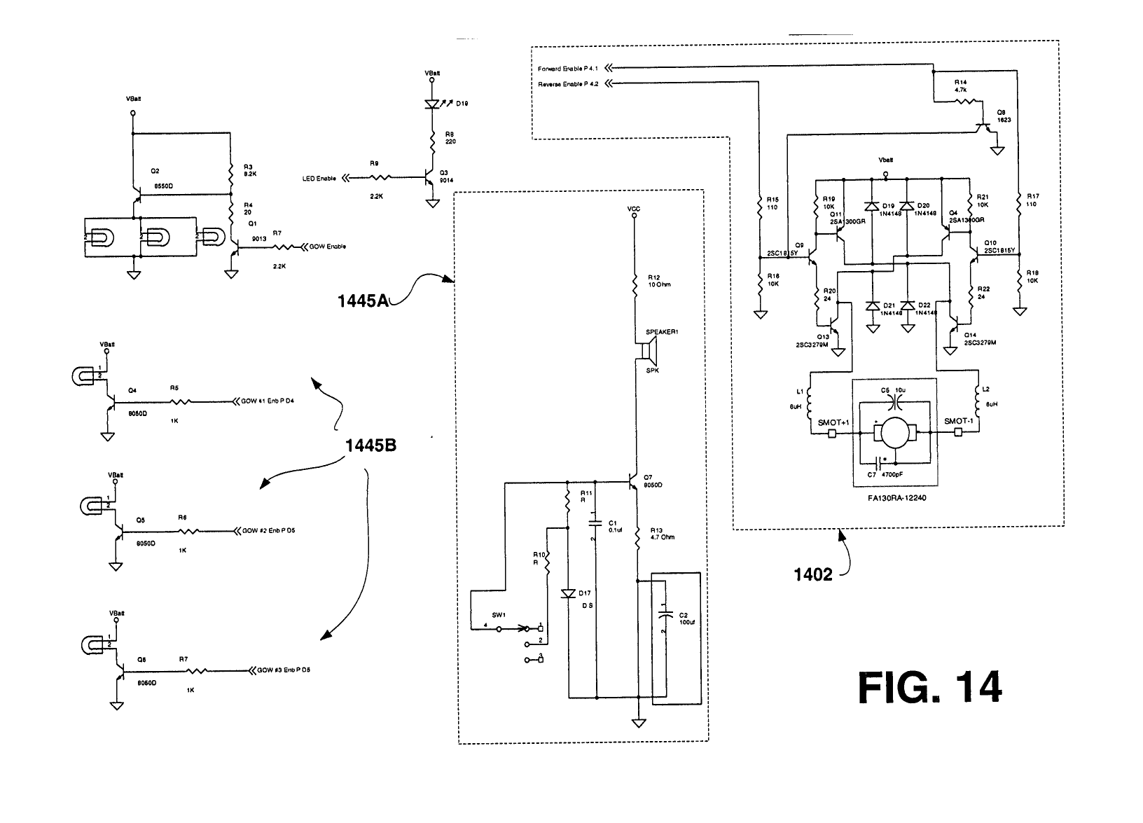

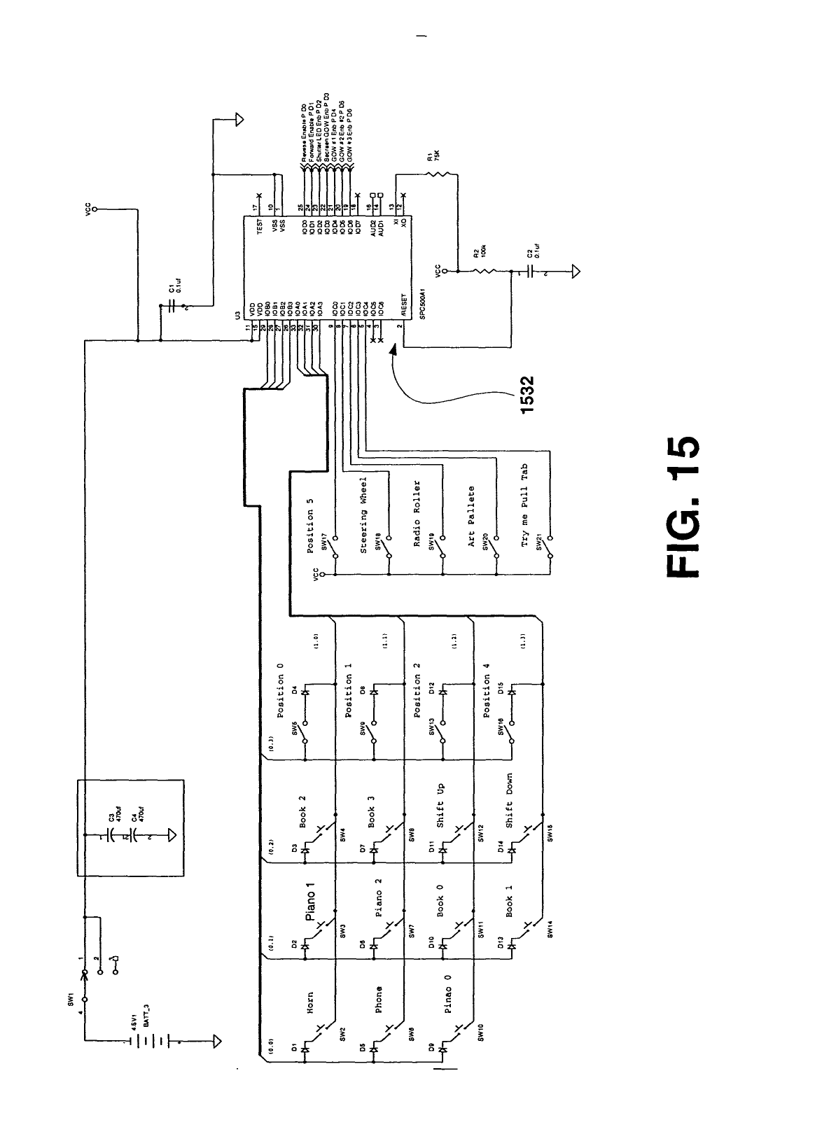

FIGS. 14 and 15 are electrical schematic diagrams according to exemplary embodiments of the invention. FIG. 14 illustrates a an audio output transducer 1445A, and a drive circuit 1402 that enables both a forward drive function and a reverse drive function, thereby permitting an image-bearing substrate to be moved in different directions depending on the direction selected by a user. FIG. 14 also illustrates various visual outputs 1445B (implemented as grain-of-wheat incandescent lights).

FIG. 15 illustrates a controller 1532 and a number of switches providing input to controller 1532 and each producing a number of outputs from controller 1532. In some instances those switches or actuators actuate sensory outputs that are not associated with the image being disposed in the viewable location. These secondary activities may enhance a learning experience or the entertainment value provided to a user.

While particular, illustrative embodiments of the invention have been described, numerous variations and modifications exist that would not depart from the scope of the invention. For example, although the image-bearing substrate is described above as being wound around a supply spool and a take-up spool, in an alternative embodiment, the image-bearing substrate can be a continuous sheet of material that extends around pulleys in a manner similar to a conveyor belt.

Additionally, although the image advancing mechanism is illustrated as being contained within the housing of the entertainment device, in an alternative embodiment, at least a portion of the image advancing mechanism can be positioned outside the housing. For example, the supply spools can be positioned partially outside the housing such that they are accessible by a user and can be manually advanced and rewound.

Although the image advancing mechanism and the image-bearing substrate are generally described as being part of the overall entertainment device, in an alternative embodiment, they may be removably coupled such that the image-bearing substrate may be interchangeable to expand the useful nature of the device. Additionally, interchangeable ROM cartridges associated with each of the interchangeable image-bearing substrates could be provided.

Although the image advancing mechanism including a motor and an optical sensor described with relation to the toy table illustrated in FIG. 3, and an alternative embodiment of the image advancing mechanism including a rack and gear system described with respect to the toy camera generally illustrated in FIG. 13, it will be appreciated that the systems are alternatives to one another and are readily substituted. Additionally, toy table 300 and toy camera 400 are merely illustrative of the types of entertainment toys contemplated by the invention. For example, other embodiments of entertainment devices include, for example, a toy television, a toy computer, or a toy aquarium. As may be appreciated, the particular toys employing the invention are not to be limited to the embodiments described herein.

Although the image-bearing substrate is described as having images printed thereon, in an alternative embodiment, the image bearing substrate may be drawn on by a user so the user can provide their own images. Additionally, in such an embodiment, the ROM may be replaced with a recordable memory so that the user can record and play back sound associated with the drawn image.

Although the images are described as individual images, in an alternative embodiment, each image can be a scene from a story or an image associated with a particular song. As the images pass through the viewing window, the audible output is associated with the portion of the story or the song.

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalence.

The previous description of the embodiments is provided to enable any person skilled in the art to make or use the invention. While the invention has been particularly shown and described with reference to embodiments thereof, it will be understood by those skilled in art that various changes in form and details may be made therein without departing from the spirit and scope of the invention.

1. An apparatus, comprising:
a body defining a viewing aperture;
an opaque substrate bearing a first image and a second image, said opaque substrate disposed within said body and movable between a first position in which said first image is disposed within said viewing aperture and a second position in which said second image is disposed within said viewing aperture; and
an output generator coupled to said body, said output generator configured to generate a first output associated with said first image when said substrate is disposed in the first position and a second output associated with said second image when said substrate is disposed in the second position.

2. The apparatus of claim 1, wherein:
said substrate further bears a third image and is further movable to a third position in which said third image is disposed within said viewing aperture; and
said output generator is further configured to generate a third output associated with said third image when said substrate is disposed in the third position.

3. The apparatus of claim 1, further comprising:
an actuator coupled to said body, said actuator being coupled to said substrate and configured to move said substrate between the first, second and third positions.

4. The apparatus of claim 1, said substrate being a flexible sheet, said apparatus further comprising:
a supply spool coupled to said body, a portion of said substrate being wound about said supply spool.

5. The apparatus of claim 4, further comprising:
a take-up spool, a portion of said substrate being wound about said take-up spool, such that when said substrate is in the first position, at least a portion of said second image is disposed on said supply spool, and when said substrate is in the second position, at least a portion of said first image is disposed on said take-up spool.

6. The apparatus of claim 1, said substrate being a flexible sheet formed as a continuous loop, the apparatus further comprising:
a first roller; and
a second roller, said substrate being disposed on said first roller and said second roller such that movement of at least one of said first roller and said second roller causes movement of said substrate.

7. The apparatus of claim 1, further comprising:
an input device coupled to the output generator, said input device being configured to cause said output generator to output a third output associated with said first image, different from said first output, when said substrate is in said first position.

8. The apparatus of claim 7, wherein said input device is a first input device, the apparatus further comprising:
a second input device coupled to the output generator, said second input device configured to cause said output generator to output a fourth output associated with said first image, different from said first output and said third output, when said substrate is in said first position.

9. The apparatus of claim 1, wherein said output generator is configured to generate said first output in association with movement of said substrate to said first position.

10. The apparatus of claim 1, further comprising an input device configured to cause said output generator to produce said first output.

11. A method, comprising:
disposing a first image in a viewable position, said first image being disposed on an opaque substrate;
producing a first sensory output associated with said first image;
disposing the first image in a non-viewable position;
disposing a second image in a viewable position, said second image being disposed on the opaque substrate; and
producing a second sensory output associated with the second image.

12. The method of claim 11, further comprising:
disposing the second image in a non-viewable position;
disposing a third image in a viewable position, said third image being disposed on the opaque substrate; and
producing a third sensory output associated with the third image.

13. The method of claim 11, wherein dispensing the first image in a viewable position includes disposing the first image in a viewable position using an actuator.

14. The method of claim 11, the substrate being a flexible substrate, the method further comprising:
dispensing an image-bearing portion of the substrate from a supply spool, the image-bearing portion bearing at least the first image.

15. The method of claim 11, wherein producing the first sensory output is associated with movement if the substrate to the viewable position.

16. An apparatus, comprising:
a body;
a first opaque substrate bearing a first image and coupled to said body for movement between a viewable position in which said first image is viewable and a hidden position in which said first image is not viewable;
a second opaque substrate bearing a second image and coupled to said body for movement between a viewable position in which said second image is viewable and a hidden position in which said second image is not viewable; and
an output generator coupled to said body and configured to generate a first output associated with said first image when said first substrate is disposed in said viewable position and a second output associated with said second image when said second substrate is disposed in said viewable position.

17. The apparatus according to claim 16, wherein said first and second substrate are adjacent to one another.

18. The apparatus of claim 17, wherein the first and second substrate form a continuous substrate.

19. The apparatus of claim 18, further comprising:
a first roller; and
a second roller, said continuous substrate being a continuous loop disposed on said first and second rollers, such that movement of said rollers causes movement of said continuous substrate.

20. The apparatus of claim 16, wherein said output generator configured to generate the first output in association with movement of said first substrate to said viewable position.

21. The apparatus of claim 16, further comprising an input device configured to cause said output generator to generate the first output.

22. The apparatus of claim 16, further comprising:
an actuator coupled to said body, said actuator being coupled to said substrate and configured to move said substrate between the first, second and third positions.

23. The apparatus of claim 16, said substrate being a flexible sheet, the apparatus further comprising:
a supply spool coupled to said body at least a portion of said substrate being wound about said supply spool.

24. The apparatus of claim 23, further comprising:
a take-up spool, at least a portion of said substrate being wound about said take-up spool, such that when said substrate is in the first position, at least a portion of said second image is disposed on said supply spool, and when said substrate is in the second position, at least a portion of said first image is disposed on said take-up spool.
